(19) United States
(12) Patent Application Publication
(10) Pub. No.: US 2013/0204836 A1
(43) Pub. Date: Aug. 8, 2013

(54) METHOD AND APPARATUS FOR CONSTRUCTING DATA WAREHOUSE TO MANAGE MASS BUILDING ENERGY INFORMATION

(71) Applicants: Chang Sic CHOI, Daejeon (KR); Youn Kwae JEONG, Daejeon (KR); Il Woo LEE, Daejeon (KR)

(72) Inventors: Chang Sic CHOI, Daejeon (KR); Youn Kwae JEONG, Daejeon (KR); Il Woo LEE, Daejeon (KR)

(73) Assignee: Electronics and Telecommunications Research Institute, Daejeon (KR)

(21) Appl. No.: 13/612,379

(22) Filed: Sep. 12, 2012

(30) Foreign Application Priority Data
Feb. 8, 2012 (KR) 10-2012-0012941

(51) Int. Cl. G06F 17/30

(52) U.S. Cl. CPC G06F 17/30563
USPC 707/602

(57) ABSTRACT

A method and apparatus for constructing a data warehouse for managing mass building energy information are provided. The apparatus for constructing a data warehouse in order to manage mass building energy information includes a primitive database generator for constructing primitive databases in each building based on energy control point information, a time series data warehouse generator for generating time series data warehouses based on the constructed primitive databases, a space time series data warehouse generator for reconstructing the generated time series data warehouses based on an object construction information table including space information about objects for control points of the plurality of buildings to be controlled to generate space time series data warehouses, and a view database generator for generating view databases by a search condition in accordance with the search condition for energy usage information based on the generated space time series data warehouses.

### CROSS-REFERENCE TO RELATED APPLICATION

This application claims the priority benefit of Korean Patent Application No. 10-2012-0012941 filed on Feb. 8, 2012, in the Korean Intellectual Property Office, the disclosure of which is incorporated herein by reference.

### BACKGROUND

1. Field of the Invention

The present invention relates to a method and an apparatus for constructing a data warehouse to manage mass building energy information capable of constructing a data warehouse by collecting a large amount of energy control information from a plurality of buildings and for managing the constructed data warehouse in order to effectively monitor, analyze, compile statistics on, and report building energy information.

2. Description of the Related Art

With the development of industrial technology, a demand for various energy saving technologies to manage the energy crisis and control greenhouse gas emissions is increasing. When the use of energy is analyzed on a national level, it is found that most energy is used by industry, transportation, and buildings, including commercial and residential buildings. As such, various energy saving technologies to be utilized by buildings are being developed and applied.

Technologies related to saving energy by optimal management of various building automation systems (BAS) such as cooling and heating systems based on a cold heat source, power systems, and illumination systems are being actively studied and applied. Recently, technologies establishing and applying an optimal management policy, in accordance with interior and exterior conditions of buildings, in view of managing buildings to save energy and of continuously maintaining energy efficiency by periodically evaluating energy efficiency are being studied.

In particular, technologies providing statistical and analytic results of energy usage information by using energy usage information and environmental sensor information about various control points in a building, and improving energy efficiency by controlling empty rooms are being developed. As a leading study and a future business model, a study of a technology on a remote building energy control center for proving an optimal energy management service while remotely performing integrated management of a plurality of buildings is performed as an objective of research and development for not only global BAS and building energy management system (BEAMS) enterprises but also nations.

However, at present, most buildings and home energy managing systems provide summed information and simple time series statistical information about the energy usage amount information. When integrated management is to be performed remotely on the summed information and the simple time series statistical information, mass building energy information is generated and a deterioration in performance, a reduction in response speed, and a system overload resulting from access to an excess of database information to effectively support performance of an analytic and statistical function, an energy diagnostic assessment service, and an energy optimal management service is caused in various ranges.

### SUMMARY

An aspect of the present invention provides a method and apparatus for constructing a data warehouse for managing mass building energy information capable of constructing a data warehouse suited to a building energy management service for effectively supporting high speed data processing in a system for providing various building energy management services based on mass building energy data.

According to an aspect of the present invention, there is provided an apparatus for constructing a data warehouse in order to manage mass building energy information, including a primitive database generator for constructing primitive databases, in each building of a plurality of buildings to be controlled, based on energy control point information received from the plurality of buildings to be controlled, a time series data warehouse generator for generating time series data warehouses based on the constructed primitive databases, a space time series data warehouse generator for reconstructing the generated time series data warehouses based on an object construction information table including space information about objects for control points of the plurality of buildings to be controlled to generate space time series data warehouses, and a view database generator for generating view databases by a search condition in accordance with the search condition for energy usage information based on the generated space time series data warehouses.

The energy control point information includes at least one of information about equipment provided in the plurality of buildings to be controlled, environmental sensor information, and energy metering information. The primitive database generator classifies the received energy control point information and sequentially stores the classified energy control point information to construct the time series based primitive databases.

The time series data warehouse generator periodically searches the primitive databases in which the energy control point information is stored in units of seconds to generate the time series data warehouses in units of minutes, times, dates, days, months, and years.

The space time series data warehouse generator reconstructs the energy control point information by space based on the space information about the objects extracted from the object construction information table and the energy control point information stored in the time series data warehouse and a schedule to generate the space time series data warehouses.

The space time series data warehouse stores the energy control point information stored in the time series data warehouse based on a time series axis by space, further includes information about accumulated power increase by space, and, when a plurality of energy information items are collected for one object, stores at least one of a sum value and an average value as a representative value of the object in accordance with the characteristic of the object.

The view database generator generates the view databases by searching the space time series data warehouses in accordance with a search condition of a service on the energy usage information when a response request for the service on the energy usage information is received.

According to another aspect of the present invention, there is provided a method of constructing a data warehouse in order to manage mass building energy information, including constructing primitive databases in each building based on energy control point information received from the plurality of buildings to be controlled, generating time series data warehouses based on the constructed primitive databases, and reconstructing the generated time series data warehouses based on an object construction information table including space information about objects for control points of the plurality of buildings to be controlled to generate space time series data warehouses.

Since it is possible to construct a time series data warehouse and a space time series data to construct a hierarchical data warehouse, it is possible to improve performance when an energy management service is requested, and to solve system load due to the frequent generation of transaction.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an apparatus for constructing a mass building energy information data warehouse according to an embodiment of the present invention;

FIG. 2 is a diagram illustrating processes of generating a time series data warehouse from primitive databases through a schedule based time series data warehouse generator according to an embodiment of the present invention;

FIG. 3 is a diagram illustrating processes of constructing a space time series data warehouse according to another embodiment of the present invention;

FIG. 4 is a diagram illustrating the structure of the space time series data warehouse according to an embodiment of the present invention;

FIG. 5 is a diagram illustrating processes of associating a data warehouse with a remote building energy management service according to an embodiment of the present invention; and

FIG. 6 is a flowchart illustrating a method of constructing the mass building energy information data warehouse according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, the embodiments of the present invention will be described in detail with reference to the accompanying drawing.

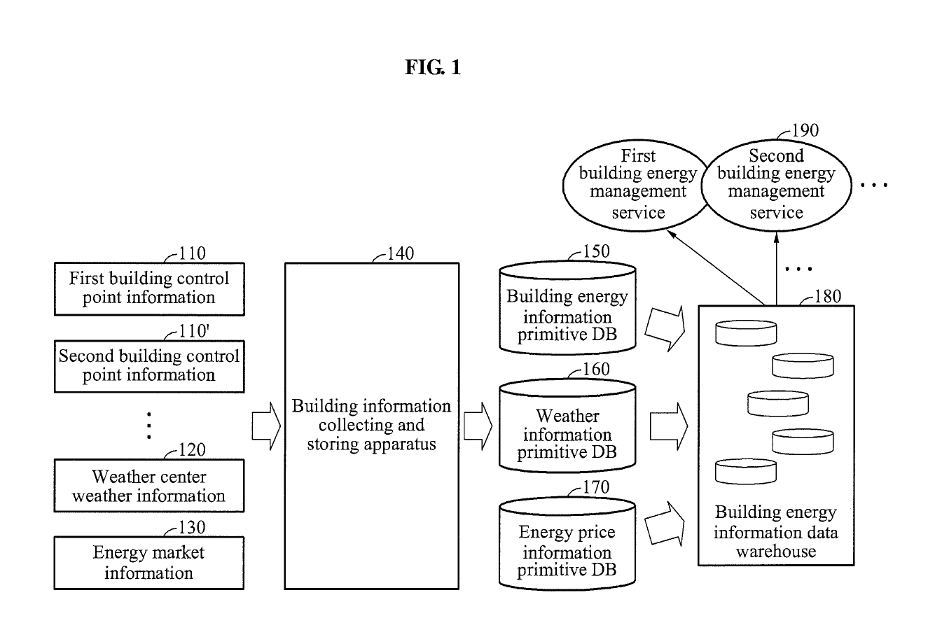

FIG. 1 is a diagram illustrating an apparatus for constructing a mass building energy information data warehouse according to an embodiment of the present invention.

An apparatus for constructing a mass building energy information data warehouse according to the present invention and a method thereof include a function of constructing primitive databases in which building energy information collected from a plurality of buildings is stored. A function of constructing a data warehouse suitable for a type of a remote building energy management service, and a scheduling management function and may be realized by a remote building energy control server for remotely performing integrated management on a skyscraper building having a mass energy control point or a mass building to be managed.

The apparatus for constructing a data warehouse according to the present invention includes a primitive database generator for constructing primitive databases in a plurality of buildings to be controlled based on energy control point information received from the plurality of buildings to be controlled, a time series data warehouse generator for generating a time series data warehouse based on the constructed primitive databases, a space time series data warehouse generator for reconstructing the generated time series data warehouse based on an object construction information table including space information about objects for the control points of the plurality of buildings to be controlled to generate a space time series data warehouse, and a view database generator for generating a view database for each search condition in accordance with search conditions for energy usage information based on the generated space time series data warehouse.

Here, energy control point information includes at least one of information about equipment provided in the plurality of buildings to be controlled, environmental sensor information, and energy metering information. The primitive database generator classifies the received energy control point information and sequentially stores the classified energy control point information to construct the time series based primitive databases.

The time series data warehouse generator periodically searches the primitive databases in which the energy control point information is stored in units of seconds to generate a time series data warehouse in units of minutes, times, dates, days, months, and years.

In addition, the space time series data warehouse generator may reconstruct the energy control point information by space, based on space information about an object extracted from an object construction information table and the energy control point information stored in the time series data warehouse, in accordance with a schedule to generate the space time series data warehouse.

The space time series data warehouse may store the energy control point information stored in the time series data warehouse by space based on a time series axis, may further include information about accumulated power increase by space, and when a plurality of energy information items about an object are collected, may store at least one of a sum value and an average value as a representative value of the corresponding object in accordance with the characteristic of the object.

When a response request for a service on the energy usage information is received, the view database generator may search the space time series data warehouse in accordance with the search condition of the service on the energy usage information to generate a view database.

Construction of a mass building energy information data warehouse by a remote building control system that collects energy related information from a plurality of buildings to provide a management service such as monitoring, analyzing and compiling statistics on building energy, and an optimal control service will be described herein with reference to FIG. 1.

Energy control point information 110 of a first building includes control point status information about building automation systems (BAS) in the building, information of an environmental sensor provided in the building, such as, temperature, humidity, intensity of illumination, and habitation, and energy metering information, such as, power sub metering, gas metering, and water metering may be transmitted to a remote place through the Internet. Energy control point information 110′ of a second building having the same values as the first building control point information 110. As illustrated in FIG. 1, building control point information may be collected for a plurality of buildings.

Weather center weather information 120 includes weather information such as temperature, humidity, weather, and atmospheric pressure published by a local weather center and may provided through the Internet.

Energy market information 130 may include energy fee market price information of electricity, gas, and water and energy price information of carbon dioxide emissions, a power trading market, and a supply contract of an energy supply business.

A building information collecting and storing apparatus 140 collects building control point information, weather information, and price information from each building, the local weather center, and an energy business through a network and analyzes the collected information. The analyzed energy related information items may be stored in chronological order of collection in the form of primitive databases (DBs) 150, 160, and 170.

The energy related information items transmitted from the respective buildings may be sequentially stored in the building energy information primitive DB 150 in accordance with the characteristic of each information item in the form of units precise to a second, for example, year-month-date-time-minute-second. Weather information of various ranges provided from the weather center may be sequentially stored in the weather information primitive DB 160. The energy price information or the energy trading market information of the energy supply business that is provided in real time, per time zone, monthly, quarterly, and annually may be sequentially stored in the energy price information primitive DB 170.

A building energy information data warehouse 180 extracts information required for the energy management service from the primitive DBs 150, 160, and 170 and converts the extracted information to store the converted information per period. Various data warehouse DBs (hereinafter referred to as DWs) suited to the energy management service may be constructed. Therefore, various building energy management services 190 such as optimally managing and reporting inquiries, statistics and analyses that are provided by the remote building energy management system may be immediately provided through the building energy information data warehouse without contacting approaching the primitive DBs directly.

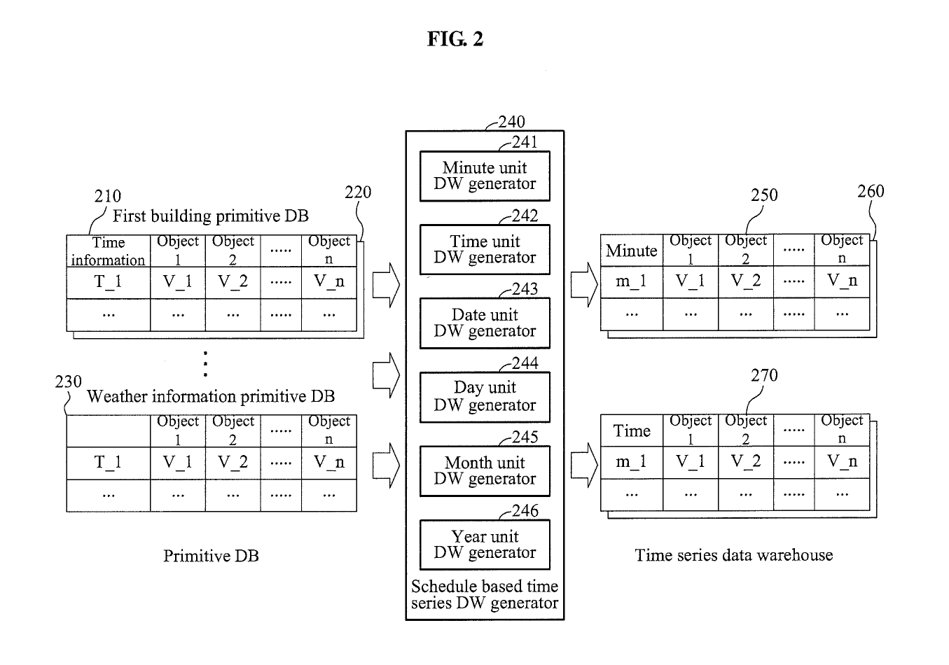

FIG. 2 is a diagram illustrating processes of generating a time series data warehouse from primitive databases through a schedule based time series data warehouse generator according to an embodiment of the present invention.

A first building primitive DB 210 and a second building primitive DB 220 illustrate the structure of the primitive DB of each building. In each of the building primitive DBs 210 and 220, objects may be aligned using time information as a main key with precise to the second in the form of year-month-date-time-minute-second. In addition, control points in each building are defined as objects so that the status values of the objects collected at a corresponding time may be stored chronologically.

A weather information primitive DB 230 may store the weather center weather information 120 of FIG. 1, collected from the local weather center, in the form of a time series similar to the building primitive DBs 210 and 220.

A schedule based time series DW generator 240 may include generators 241, 242, 243, 244, 245, and 246 for constructing a data warehouse in units of minutes, time, data, months, and years.

The minute unit DW generator 241 integrates information about objects collected from the primitive DB using units of minutes, precise to the second, to construct a time series data warehouse, for each building, in units of minutes. When a plurality of values are collected among the integrated data values in units of minutes, a representative value may be stored in accordance with the characteristic of an object such as a sum, for example, an amount of energy usage and an average, for example, a temperature sensor value. As an example, the minute unit DW generator 241 may integrate the data values of the first building primitive DB 210 and the weather information primitive DB 230 to construct a time series data warehouse 250, for the first building, in units of minutes.

Reference numeral 260 denotes a time series data warehouse that is constructed by the minute unit DW generator 241, in units of minutes, for the second building. Reference numeral 270 denotes a time series data warehouse constructed in units of time. Since a method of construction is similar to the method described above, hereinafter, a detailed description of time unit, date unit, day unit, month unit, and year unit DW generators 242 to 246 will be omitted for conciseness.

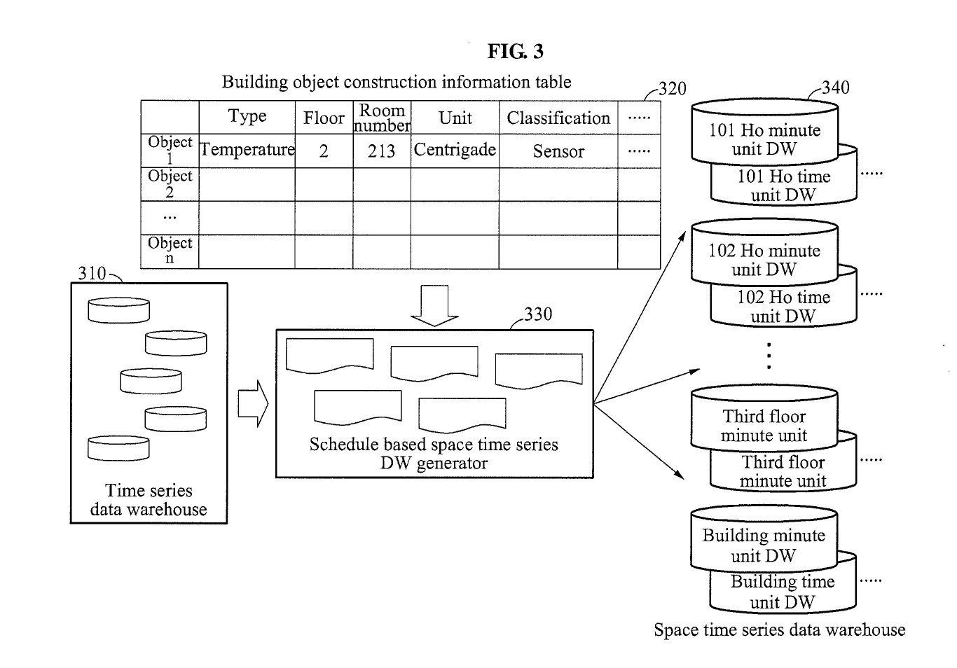

FIG. 3 is a diagram illustrating processes of constructing a space time series data warehouse according to another embodiment of the present invention. Hereinafter, processes of generating a space time series data warehouse having space series information from various time series data warehouses generated by the time series data warehouse generator will be described with reference to FIG. 3.

A time series data warehouse 310 illustrates a minute, time, date, day, month, and year unit time series data warehouse, of each building to be controlled, that is generated by the schedule based time series data warehouse generator described in FIG. 2.

A building object construction information table 320 defines the control points of a building to be controlled as objects, and the properties of the objects by a property table. Further, the building object construction information table 320 is used for constructing a space series data warehouse.

A schedule based space time series DW generator 330 reconstructs information stored in the time series data warehouse by zone, for example, a region, a room number, a floor number, and department number, from space information about an object that is extracted by the building object construction information table 320 and information stored in the time series data warehouse to construct a space time series data warehouse.

A space time series data warehouse 340 constructed by the schedule based space time series DW generator 330 has a flexible structure in which minute, time, date, day, month, and year unit time series information is stored in various zones and space property information of each object is classified so that an object that belongs to a corresponding zone is included and that necessary properties may be added to each zone. Therefore, when the energy management service is provided, although contact is made with the space time series data warehouse by various methods such as space and time, a rapid data response result may be expected.

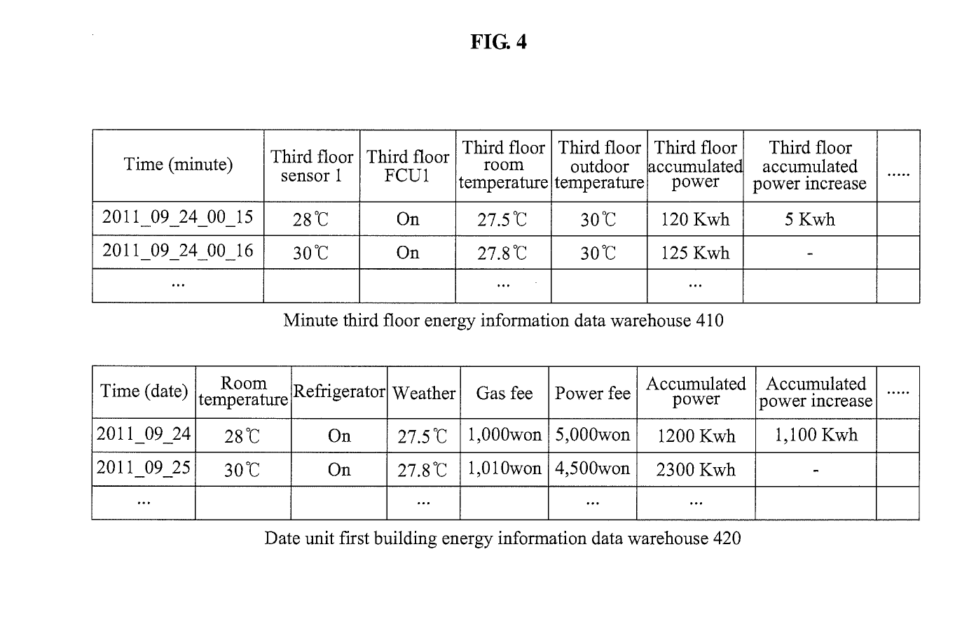

FIG. 4 is a diagram illustrating the structure of the space time series data warehouse according to the embodiment of the present invention.

Referring to FIG. 4, structures of a minute unit third floor energy information data warehouse 410 and a date unit first building energy information data warehouse 420 are illustrated.

The minute unit third floor energy information data warehouse 410 may include the status values, for example, a third floor sensor 1 and a third floor FCU 1, of the objects that belong to a third floor zone based on a minute unit, in a form of year-month-date-time-minute, time series axis and information fields such as third floor accumulated power increase defined and added to the third floor zone extracted by performing self calculation from a third floor accumulated power value. In addition, the entire energy related property data items of the first building based on a date unit in a form of year-month-date, time series axis are defined in the data unit first building energy information data warehouse 420.

Therefore, a data warehouse constructing apparatus for managing mass building energy information according to the present invention periodically manages data, through use of the above data warehouses, by a building energy managing system in which a plurality of buildings are managed as objects to be controlled and a mass control point is provided in each building to reduce a load on a system, and to improve responsiveness, quality, and reliability of a service.

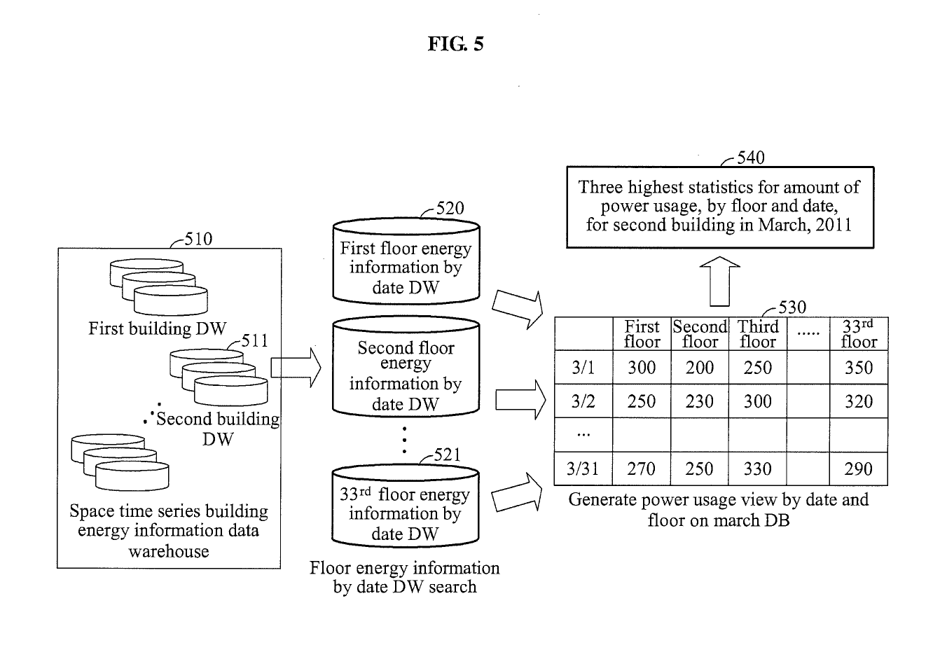

FIG. 5 is a diagram illustrating processes of associating a data warehouse with a remote building energy management service according to the embodiment of the present invention.

Space time series building energy information data warehouses 510 and 511 may be constructed in each building through processes previously described with reference to FIG. 4. A floor energy information by date DW may be located by searching for and extracting information from energy information DWs 520 and 521 constructed in each floor by date.

For example, when three highest statistics of an amount of power usage, by floor and date, of the second building 540, is requested in March, 2011, the data warehouse constructing apparatus for managing the mass building energy information according to the present invention searches for the energy information by date, DWs 520 and 521 from a first floor to a 33^{rd} floor to generate a March power usage view DB 530, by date and floor, to be used for searching for information about an amount of power usage by floor. The three highest statistics may be output to an actual service providing screen through the corresponding view DB 530.

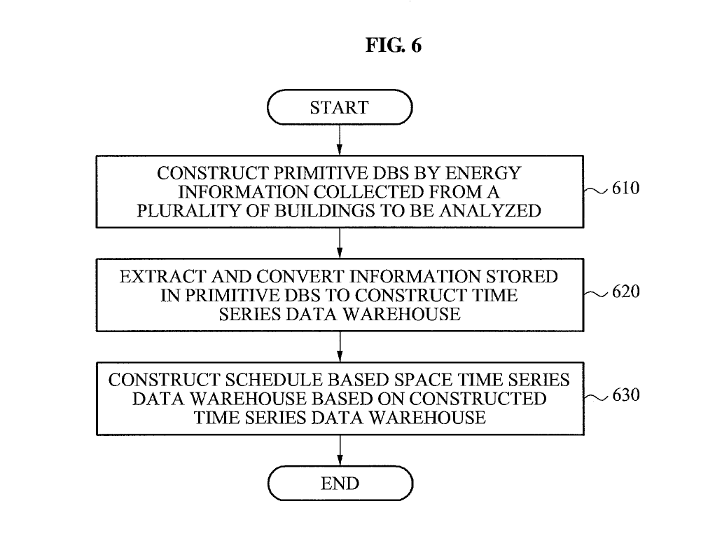

FIG. 6 is a flowchart illustrating a method of constructing the mass building energy information data warehouse according to the embodiment of the present invention.

The data warehouse constructing apparatus according to the present invention classifies energy control point information, to be analyzed, received from a plurality of buildings to be controlled, and sequentially stores the classified energy control point information to construct a time series based primitive database in each building in operation 610. Here, the classified energy control point information may include at least one of information about equipment to be controlled in the buildings, environment sensor information, and energy metering information.

Subsequently, information stored in the constructed primitive databases is extracted and converted to construct a time series data warehouse in operation 620. For example, the data warehouse constructing apparatus periodically searches the primitive databases in which the energy control point information is stored in units of seconds, to generate the time series data warehouse in units of minutes, times, dates, days, months, and years.

A schedule based space time based data warehouse is constructed by reconstructing a time series data warehouse based on an object construction information table including space information about objects for the control points of the buildings to be controlled in 630.

The space time series data warehouse constructed by the foregoing method stores the energy control point information stored in the time series data warehouse based on a time series axis, by space and may further include information about accumulated power increase, by space. In addition, when a plurality of energy information items are collected for one object, at least one of a sum value and an average value may be stored as a representative value of the corresponding object in accordance with the characteristic of each object.

When a response request for a service on the energy usage information is received, the data warehouse constructing apparatus searches the space time series data warehouse, in accordance with the search condition of the service related to the energy usage information, to generate the view database.

As described above, the data warehouse constructing apparatus and method for managing the mass building energy information according to the present invention may immediately generate a result by searching the space time series data warehouse without generating a load such as searching, processing, extracting, and storing the mass primitive DBs having second unit precision in order to obtain a service search result.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for constructing data warehouses in order to manage mass building energy information, comprising:
a primitive database generator for constructing primitive databases in each building of a plurality of buildings to be controlled, based on energy control point information received from the plurality of buildings to be controlled;
a time series data warehouse generator for generating time series data warehouses based on the constructed primitive databases;
a space time series data warehouse generator for reconstructing the generated time series data warehouses, to generate space time series data warehouses, based on an object construction information table including space information about objects for control points of the plurality of buildings to be controlled; and
a view database generator for generating view databases by a search condition in accordance with a search condition for energy usage information based on the generated space time series data warehouses.

2. The data warehouse constructing apparatus of claim 1,
wherein the energy control point information comprises at least one of information about equipment provided in the buildings to be controlled, environmental sensor information, and energy metering information, and
the primitive database generator classifies the received energy control point information and sequentially stores the classified energy control point information to construct the time series based primitive databases.

3. The data warehouse constructing apparatus of claim 1, wherein the time series data warehouse generator periodically searches the primitive databases in which the energy control point information is stored in units of seconds to generate the time series data warehouses in units of minutes, times, dates, days, months, and years.

4. The data warehouse constructing apparatus of claim 1, wherein the space time series data warehouse generator reconstructs the energy control point information by space, based on the space information about the objects extracted from the object construction information table and the energy control point information stored in the time series data warehouse and a schedule to generate the space time series data warehouses.

5. The data warehouse constructing apparatus of claim 1, wherein the space time series data warehouse stores the energy control point information stored in the time series data warehouse based on a time series axis by space, comprising information about accumulated power increase by space, and when a plurality of energy information items are collected for one object, stores at least one of a sum value and an average value as a representative value of the object in accordance with the characteristic of the object.

6. The data warehouse constructing apparatus of claim 1, wherein the view database generator generates the view databases by searching the space time series data warehouses in accordance with a search condition of a service on the energy usage information when a response request for the service on the energy usage information is received.

7. A method of constructing a data warehouse in order to manage mass building energy information, the method comprising:
constructing primitive databases in each building of a plurality of buildings to be controlled based on energy control point information received from the plurality of buildings to be controlled;
generating time series data warehouses based on the constructed primitive databases; and
reconstructing the generated time series data warehouses based on an object construction information table including space information about objects for control points of the plurality of buildings to be controlled to generate space time series data warehouses.

8. The method of claim 7,
wherein the energy control point information comprises at least one of information about equipment provided in the plurality of buildings to be controlled, environmental sensor information, and energy metering information, and
wherein, in the constructing of the primitive databases, the received energy control point information is classified and is sequentially stored to construct the time series based primitive databases.

9. The method of claim 7, wherein, in the generating of the time series data warehouses, the primitive databases in which the energy control point information is stored in units of seconds are periodically searched to generate the time series data warehouses in units of minutes, times, dates, days, months, and years.

10. The method of claim 7, wherein, in the generating of the space time series data warehouses, the energy control point information is reconstructed by space based on the space information about the objects extracted from the object construction information table and the energy control point information stored in the time series data warehouse and a schedule to generate the space time series data warehouses.

11. The method of claim 7, wherein the space time series data warehouse stores the energy control point information stored in the time series data warehouse based on a time series axis by space, comprising information about accumulated power increase by space, and, when a plurality of energy information items are collected for one object, stores at least one of a sum value and an average value as a representative value of the object in accordance with the characteristic of the object.

12. The method of claim 7, further comprising generating the view databases by searching the space time series data warehouses in accordance with a search condition of a service on the energy usage information when a response request for the service on the energy usage information is received.
